(19) United States
(12) Patent Application Publication
(10) Pub. No.: US 2024/0320586 A1
(43) Pub. Date: Sep. 26, 2024

(54) RISK MITIGATION FOR CHANGE REQUESTS

(71) Applicant: INTERNATIONAL BUSINESS MACHINES CORPORATION, Armonk, NY (US)

(72) Inventors: Emmanuel YASHCHIN, Yorktown Heights, NY (US); Nianjun ZHOU, Chappaqua, NY (US); Jonathan D. DUNNE, Dungarvan (IE); Anuradha BHAMIDIPATY, Yorktown Heights, NY (US)

(21) Appl. No.: 18/189,988

(22) Filed: Mar. 24, 2023

(51) Int. Cl. G06Q 10/0635

(52) U.S. Cl. CPC G06Q 10/0635

(57) ABSTRACT

A method, system, and computer program product that is configured to: receive at least one change request (CR) for a modification in a cloud environment; predict an outage risk for the at least one CR in the cloud environment using a predictive machine learning model which predicts based on historical data and historical features; and suggest at least one recommendation to mitigate the outage risk for the at least one CR in the cloud environment. In particular, embodiments are based on feature objects (or feature sets) (f, e), which are separation of factors pertaining to the CR and to a predicted environment at a currently scheduled CR execution time, as well as dependencies on the features of other CRs in the queue.

### BACKGROUND

Aspects of the present invention relate generally to risk mitigation and, more particularly, to a system, method, and computer program product for managing risks of planned changes to a cloud computing environment.

In the cloud computing environment, site reliability engineering (SRE) focuses on the uptime of products and services running on a platform. Downtime and data flow delays may lead to violations of a service level agreement (SLA) that result in penalties and refunds to customers. SRE teams may proactively build and implement services to make information technology (IT) infrastructure and support more efficient. SRE teams may cover a wide range of operations, from adjustments, monitoring, alerting, and changing coding in production. SRE teams also ensure that post-incident reviews are documented and appropriate actions are taken.

### SUMMARY

In a first aspect of the invention, there is a computer-implemented method including: receiving, by a processor set, at least one change request (CR) for a modification in a cloud environment; predicting, by the processor set, an outage risk for the at least one CR in the cloud environment using a predictive machine learning model which predicts based on historical data and historical features; and suggesting, by the processor set, at least one recommendation to mitigate the outage risk for the at least one CR in the cloud environment.

In another aspect of the invention, there is a computer program product including one or more computer readable storage media having program instructions collectively stored on the one or more computer readable storage media. The program instructions are executable to: receive at least one change request (CR) for a modification in a cloud environment; predict an outage risk for the at least one CR in the cloud environment using a predictive machine learning model which predicts based on historical data and historical features; suggest at least one recommendation to mitigate the outage risk for the at least one CR in the cloud environment; and predict a plurality of environmental variables at a time of scheduled deployment for the at least one CR in the cloud environment.

In another aspect of the invention, there is a system including a processor set, one or more computer readable storage media, and program instructions collectively stored on the one or more computer readable storage media. The program instructions are executable to: receive at least one change request (CR) for a modification in a cloud environment; predict an outage risk for the at least one CR in the cloud environment using a predictive machine learning model which predicts based on historical data and historical features; estimate a magnitude of the outage risk for the at least one CR in the cloud environment; and suggest at least one recommendation to mitigate the outage risk for the at least one CR in the cloud environment.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of a risk estimator of FIG. 2 in accordance with aspects of the present invention.

FIG. 4 shows an example of an island graph associated with the risk estimator of FIG. 3 in accordance with aspects of the present invention.

FIG. 5 shows an example of a block diagram of a label and attribute generator associated with the risk estimator of FIG. 3 in accordance with aspects of the present invention.

FIG. 6 shows an example of an attribute estimator associated with the risk estimator of FIG. 3 in accordance with aspects of the present invention.

FIG. 7 shows an example of a predictive machine learning model associated with the risk estimator of FIG. 3 in accordance with aspects of the present invention.

FIG. 8 shows a block diagram of a risk mitigator of FIG. 2 in accordance with aspects of the present invention.

FIG. 9 shows a block diagram of an action recommender of FIG. 2 in accordance with aspects of the present invention.

FIG. 10 shows a block diagram of an environment predictor of FIG. 2 in accordance with aspects of the present invention.

FIG. 11 shows a flowchart of an exemplary method in accordance with aspects of the present invention.

### DETAILED DESCRIPTION

Aspects of the present invention relate generally to risk mitigation and, more particularly, to a system, method, and computer program product for managing risks of planned changes to a cloud computing environment. According to aspects of the invention, the system, method, and computer program product may manage change request queues, track the risks of a change request implementation, analyze a correlation between various change requests in the change request queues, alert a change request team about potential dangers, and suggest risk mitigation actions.

In embodiments, aspects of the present invention provide a systematic way of performing risk assessment by alerting a change request (CR) team to potential dangers related to a CR queue status and suggesting preemptive actions for risk mitigation. In this manner, implementations of the present invention may forecast a state of an operation environment at a scheduled launch time and may estimate risk of outages based on the forecast, the features of the CR, and features of other CR in the queue.

In embodiments, aspects of the present invention examine large volumes of data related to a CR and a request for root cause analysis (RCA) database and return results indicating that procedures for a system type are feasible (i.e., have a low probability of an outage). Embodiments of the present invention may include a system, method, and computer program product for risk evaluation and management of change request (CR) queues.

According to an aspect of the invention, the system, method, and computer program product implements risk mitigation in executing scheduled system change requests. For example, the computer-implemented method includes: tracking scheduled change request deployments; predicting environmental variables associated with a scheduled change request deployment; estimating, by a machine learning model, a change request deployment risk according to a requested change and the predicted environmental variables; identifying mitigating actions for a change request deployment risk according to an adjustable feature of the change request; prioritizing the mitigating actions according to an action-specific identifier; and displaying a list of scheduled deployments together with the mitigating action according to the prioritization.

Aspects of the present invention include a method, system, and computer program product for improving risk mitigation of change request (CR) queues. Conventional systems rely on architecture changes and simple remedial actions. However, by relying on architecture changes and remedial actions in conventional systems, the probability of an outage may not be able to be determined until after an event is finished. Further, by relying on architecture changes and remedial actions in conventional systems, root cause analysis may not be possible through manual analysis. In embodiments, by implementing the method, system, and computer program product herein, change request (CR) queues may be managed, the risks of a CR implementation may be managed, a correlation between various change requests in the change request queues may be analyzed, a change request team may be alerted about potential dangers, and risk mitigation actions may be suggested. Accordingly, implementations of the present invention provide an improvement (i.e., technical solution) to a problem arising in the technical field of change request (CR) queue management in a cloud environment. In particular, embodiments of the present invention may include a risk estimator, a risk mitigator, an action recommender, and an environment predicator to provide an improvement in CR queue management in a cloud environment. Also, embodiments of the present invention may not be performed mentally or may not be performed in a human mind because aspects of the present invention use predictive machine learning models which are trained using historical data to improve risk mitigation within the cloud environment.

Implementations of the invention are necessarily rooted in computer technology. For example, the step of predicting an outage risk for a change request in the cloud environment using a predictive machine learning model which predicts based on historical data and historical features is computer-based and cannot be performed in the human mind. Training on historical data using a predictive machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the predictive machine learning model. Values of these weights are adjusted, e.g., via backpropagation or stochastic gradient descent, when training the predictive machine learning model and are utilized in calculations when using the trained predictive machine learning model to generate an output in real time (or near real time). Given this scale and complexity, it is simply not possible for the human mind, or for a person using pen and paper, to perform the number of calculations involved in training and/or using a predictive machine learning model.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as risk mitigation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

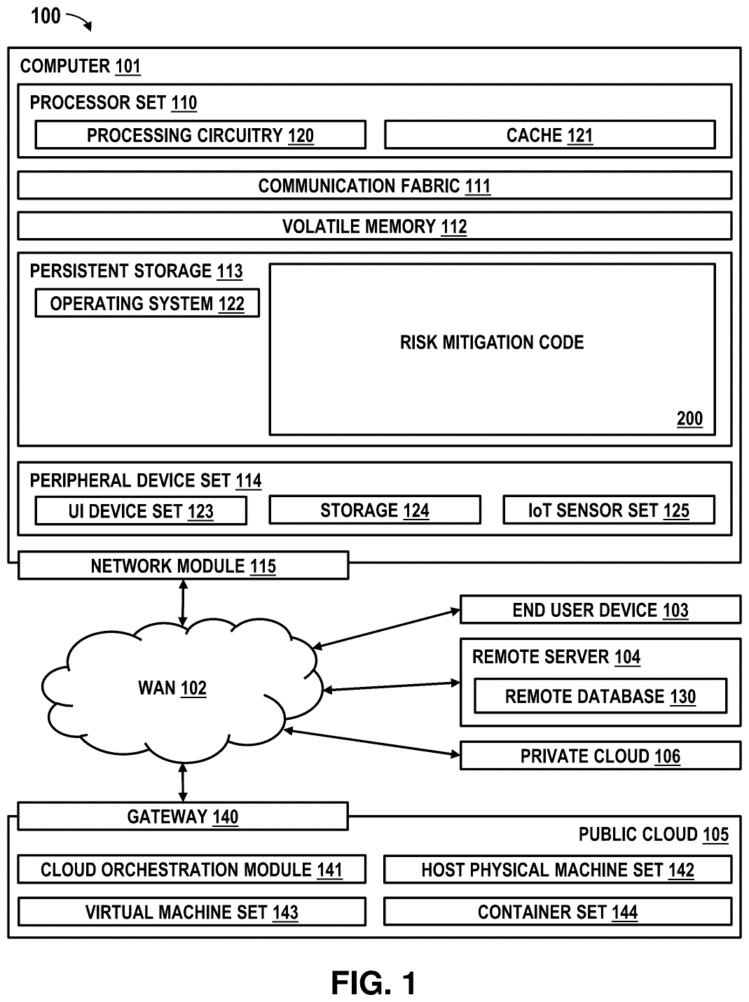

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

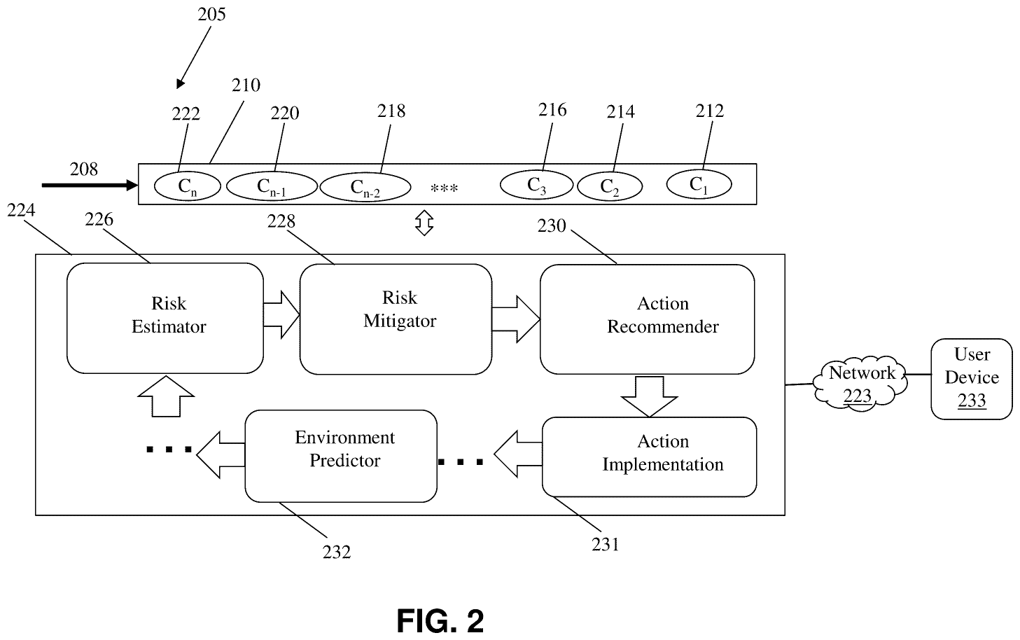

FIG. 2 shows a block diagram of an exemplary environment 205 in accordance with aspects of the invention. In embodiments, the environment 205 may include a plurality of change requests (CRs) 208 which are fed into a CR queue 210. In embodiments, a change request (CR) comprises a formal proposal for an alteration or modification to a product or system in a cloud hosting operation. In particular, the CR queue 210 is a set of CRs for which deployment has not yet started. As an example, the CR queue 210 may include a first change request C₁ 212, a second change request C₂ 214, a third change request C₃ 216, . . . , a (n−2) change request Cₙ₋₂ 218, a (n−1) change request Cₙ₋₁ 220, and an n change request Cₙ 222, with n being an integer. However, embodiments are not limited, and the CR queue 210 may include only one CR or any integer number of CRs greater than one.

In embodiments, the environment 205 also includes a cloud system 224 which includes a risk estimator 226, a risk mitigator 228, an action recommender 230, an action implementation 231, and an environment predictor 232. In other embodiments, the action implementation 231 may be optional. In embodiments, the cloud system 224 may be connected to a user device 233 through a network 223. In embodiments, the cloud system 224 may comprise one or more instances of the computer 101 of FIG. 1, the network 223 may comprise one or more instances of a WAN 102 of FIG. 1, and the user device 233 may comprise one or more instances of end user device 103 or remote server 104 of FIG. 1. In other embodiments, the cloud system 224 may be one or more instances of a public cloud 105 or a private cloud 106 of FIG. 1. In further embodiments, the cloud system 224 may include a software system with a user interface (UI) dashboard, hardware circuits, processor sets, and/or a combination of hardware and software.

In embodiments, the cloud system 224 of FIG. 2 comprises a risk estimator 226, a risk mitigator 228, an action recommender 230, an action implementation 231, and an environment predictor 232, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The cloud system 224 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

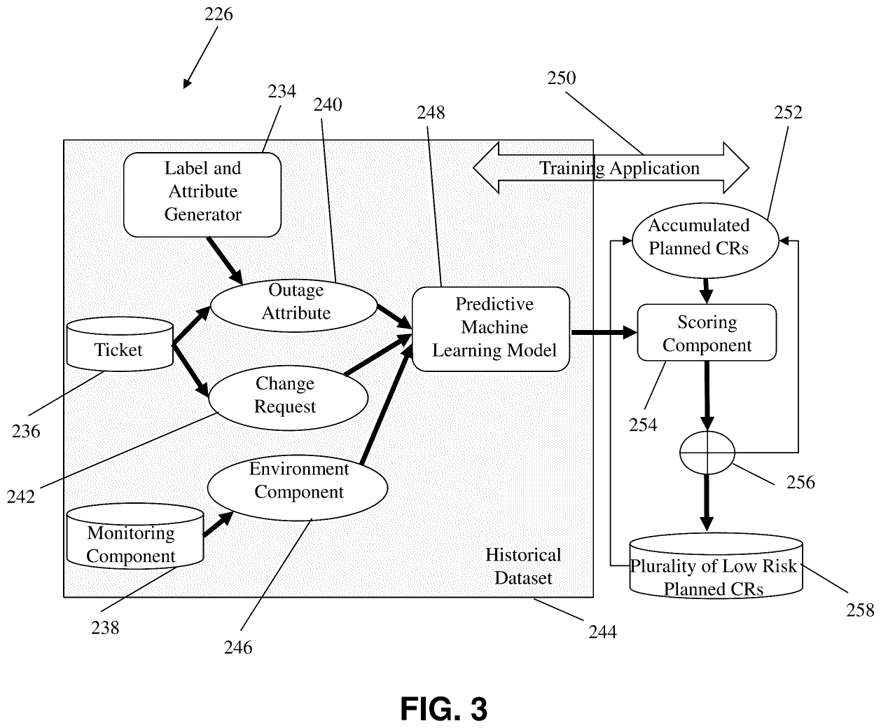

In aspects of the present invention, the risk estimator 226 of FIG. 2 is configured to predict an outage risk based on a predictive machine learning model. The risk estimator 226 may also receive inputs of historical CRs, requests for root cause analysis (RCE) in a database, outages, and system metric measurements. The risk estimator 226 may also calculate a potential effect of scheduled changes (e.g., CRs) that are scheduled to be deployed in the future. In particular, the risk estimator 226 may calculate the potential effect of scheduled changes by taking into account any dependencies that may occur as a result of the scheduled changes. For example, if a first change request (CR) is implemented prior to a second change request (CR), the risk estimator 226 may perform an analysis to determine an impact of the first CR on the second CR. In embodiments, the risk estimator 226 may maintain a complete picture of risk and will described in further detail in FIGS. 3-7.

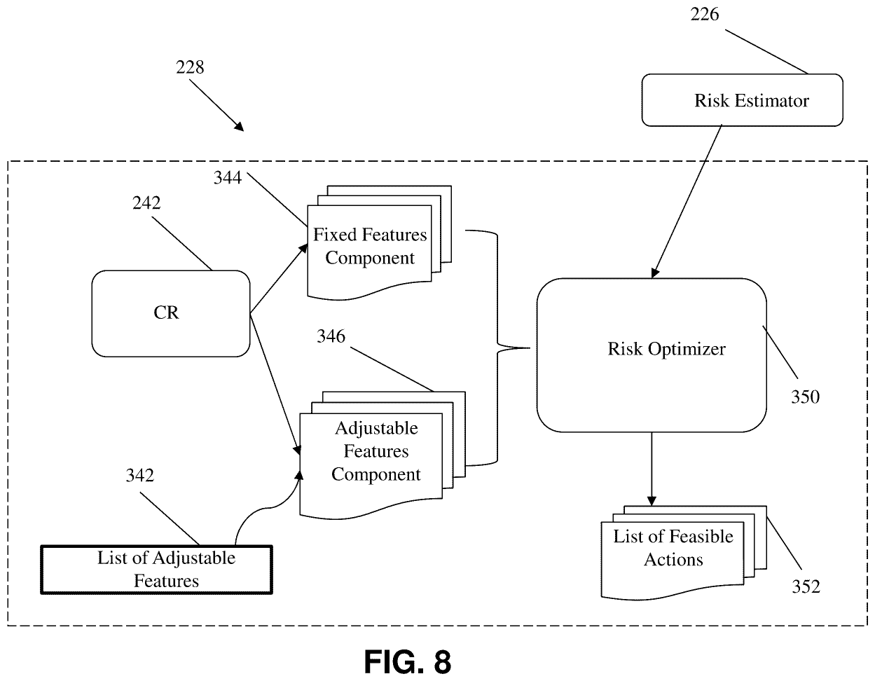

In aspects of the present invention, the risk mitigator 228 (may also be called a risk optimizer 228) of FIG. 2 is configured to include an optimization engine including one or more algorithms that optimize risk based on an outcome of the risk estimator 226. In other words, the risk mitigator 228 may give options to minimize and mitigate the risks based on the outcome of the risk estimator 226. The risk mitigator 228 will be described in further detail in FIG. 8.

In aspects of the present invention, the action recommender 230 of FIG. 2 is configured to suggest alternatives for CRs or suggest modifications of existing CRs. For example, the action recommender 230 may suggest to perform A action, perform B action, and perform C action. In an example, the action recommender 230 may suggest to swap the first CR with the second CR to mitigate a risk of an outage. In another example, the action recommender 230 may suggest to delay a CR to mitigate the risk of the outage. The action implementor 231 may automatically implement at least one of the suggestions from the action recommender 230. In other embodiments, the action implementor 231 may be optional because the actions may be implemented manually and not automatically.

In aspects of the present invention, the environment predictor 232 of FIG. 2 is configured to predict key environmental variables at a time of scheduled deployment of a CR in the CR queue 210. In embodiments, these key environmental variables may play a role in the predictive machine learning model of the risk estimator 226. For example, the environment predictor 232 may describe environmental variables at the time of scheduled deployment in a cloud environment. In other examples, the environment predictor 232 may provide an alert that a hard drive maintenance is occurring at the time of scheduled deployment, software updates and/or patches may be run at a time of scheduled deployment which is a low-utilization period, etc.

In an example scenario of FIG. 2, there are three change requests: a first change request CR1 which corresponds with replacing a storage unit with a new model, a second change request CR2 which corresponds with migrating to a new operating system (OS) version, and a third change request CR3 which corresponds with implementing a new security policy. In aspects of the present invention, the system, method, and computer program product described herein may predict that the risk of these CRs to cause an outage are 0.01, 0.02, and 0.05, respectively.

In the example scenario of FIG. 2, the system, method, and computer program product described herein examines the features of CRs (i.e., CR1, CR2, and CR3) and determines that by implementing actions (i) delaying the implementation of CR1 by two days and (ii) switching an implementation of CR3 to precede CR2 (i.e., switching the order of the CRs), an overall impact of risk in the sequency may be decreased by 1 point (i.e., −1 point impact), with individual outage risks being 0.02.0.02, and 0.01, respectively. The system, method, and computer program product described herein also may determine that 90% of the risk benefit occurs from a time shift of CR2 due to the proximity of the initial implementation date of CR2 at a national holiday. The system, method, and computer program product may also determine that by implementing actions (i) and (ii), the cost may be approximately $100. The system, method, and computer program product may also look at 1000 other possible actions and may find three other actions that were overall beneficial in terms of impact per cost invested. The system, method, and computer program product may then rank-order the four options (i.e., first option described plus three other actions) and may determine that actions (i) and (ii) described above was at the top of the rank-ordered list, with an overall impact of (− 1/100) points per dollar.

In the example scenario of FIG. 2, the action recommender 230 suggests to implement actions (i) and (ii) at a current decision point. Further, the action recommender 230 may not recommend any other actions at this time, but may recommend to re-evaluate a status of the CR queue 210 in nine hours.

FIG. 3 shows a block diagram of a risk estimator of FIG. 2 in accordance with aspects of the present invention. In FIG. 3, the block diagram of the risk estimator 226 includes a label and attribute generator 234, a ticket 236, a monitoring component 238, an outage attribute module 240, a change request (CR) 242, a historical dataset 244, an environment component 246, a predictive machine learning model 248, a training application 250, a plurality of accumulated planned CRs 252, a scoring component 254, an adjustment component 256, and a plurality of low risk planned CRs 258. In further embodiments, each of the label and attribute generator 234, the monitoring component 238, the environment 246, the predictive machine learning model 248, the training application 250, the scoring component 254, and the adjustment component 256 may include a software system with a user interface (UI) dashboard, hardware circuits, processor sets, and/or a combination of hardware and software.

In aspects of the present invention, the label and attribute generator 234 of FIG. 3 is configured to create a data set for training and test. In embodiments, data sets may comprise feature sets or feature objects. Feature objects may contain features and also methods such as object oriented programming (OOP). Two types of feature objects are denoted by letters “f” and “c”. The feature objects (or feature sets) of type “f” correspond to the description of the CR. Typically, these feature objects (or features sets) originate from the fields of the form; hence, the letter “f”. The feature objects (or feature sets) of type “c” originate from the cloud environment at the time of the CR deployment. In embodiments, the cardinalities of the two sets are equal by having a one to one mapping from one object (i.e., f) to another object (i.e., e). Each edge of the mapping may contain a tag which is 1 or 0 to indicate an outage failure (RCA analysis) at a time of CR deployment or afterwards. Other attributes may also be associated with the edge of the mapping.

In aspects of the present invention, the label and attribute generator 234 of FIG. 3 includes another set of objects that are related to planned CRs (i.e., CRs that are currently in the queue). The corresponding changes related to the CRs in the queue are scheduled to be implemented in the future. The environment predictor 232 is configured to generate a projected state of the cloud environment at the scheduled deployment time. In embodiments, the attribute generator 234 is configured to predict tags, labels, and attributes of the another set of objects.

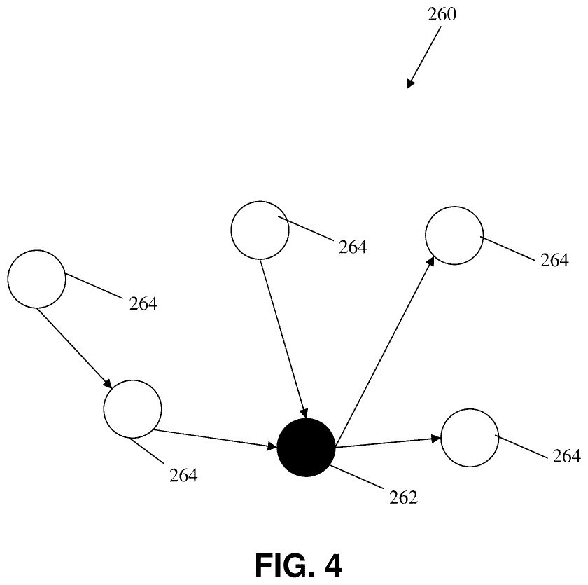

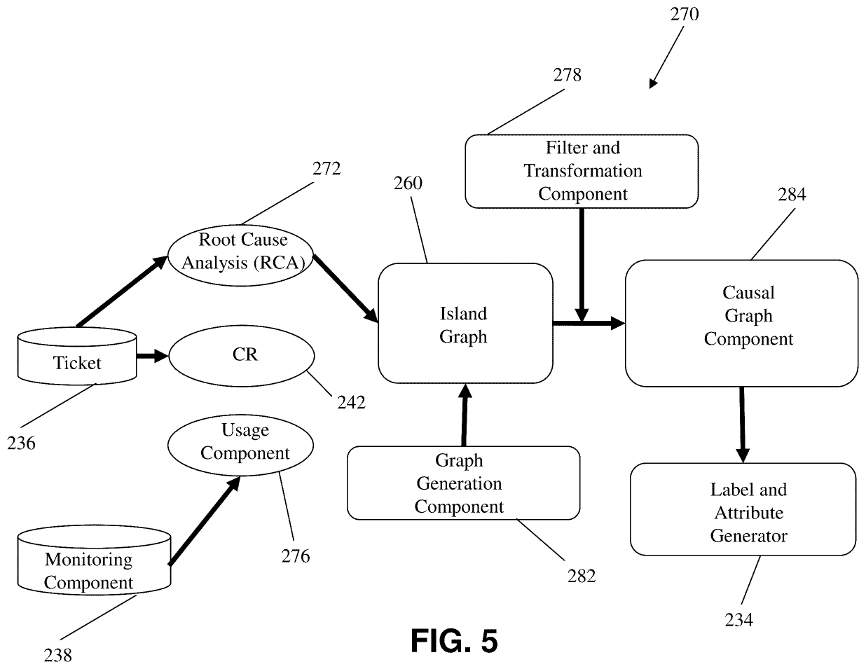

In aspects of the present invention, the label and attribute generator 234 identifies which CRs will result in an outage by assigning a proper outage label. In particular, the label and attribute generator 234 identifies which current CRs will result in an outage by looking at outages and descriptions of completed CRs, environmental data at an implementation time of the completed CRs, and root cause analysis (RCA) data of completed CRs and estimating a probability of an outage for the current CRs based on the historical data. Further, the label and attribute generator 234 identifies CRs that will result in an outage for training and test purposes. In initial stages, a history of the CRs (i.e., the CR records) may not always provide the label information indicating that it caused an outage. Therefore, in embodiments, a labeling algorithm (e.g., island algorithm) is used to generate labels of the CRs. In particular, the label and attribute generator 234 may use the island algorithm to generate an island graph 260 for each CR using completed CRs and RCA datasets. The island graph 260 generated by the label and attribute generator 234 is described in more detail in FIG. 4. In FIG. 3, the label and attribute generator 234 generates labels and send them to the outage attribute module 240. Further details related to the label and attribute generator 234 are described in FIG. 5.

In aspects of the present invention, the ticket 236 is received at the risk estimator 226 and information from the ticket 236 is sent to the outage attribute module 240 and the change request (CR) 242. The outage attribute module 240 receives information from the ticket 236 and the label and attribute generator 234 and sends outage attribute information related to change requests to the predictive machine learning model 248. The CR 242 also sends its information to the predictive machine learning model 248.

In aspects of the present invention, a monitoring component 238 monitors the historical dataset 244 and sends monitored and environment information to the environment component 246. In particular, the monitoring component 238 monitors the historical dataset 244 by looking at system metric environmental measurements of the historical dataset 244 at a time of implementation of a historical CR, such as software updates, an exact time of the implementation, customers served, processor utilization, network utilization, on site support level, etc. The environment component 246 then sends the monitored and environment information of the historical dataset 244 to the predictive machine learning model 248.

In aspects of the present invention, the predictive machine learning model 248 is configured to receive information from the outage attribute module 240, the CR 242, and the environment component 246 and predict an outage of a planned change request (CR) based on attributes from the outage attribute module 240, information from the CR 242, and environmental information from the environment component 246. In embodiments, the predictive machine learning model 248 comprises a machine learning model that may be implemented as a decision tree, although embodiments are not limited to a decision tree. In embodiments, the decision tree is a supervised machine learning algorithm in which a classification or regression decision tree is used to predict outages based on a planned CR. The predictive machine learning model 248 may be trained on the historical dataset 244 by the training application 250. For example, the predictive machine learning model 248 may be trained on a set of historical data pairs which include a set of historical feature objects (represented as “f”), a set of historical environment objects (represented as “e”), and labels which indicate that the historical (f, e) pair caused a historical outage to predict a future outage in a planned CR (i.e., future CR). The historical dataset 244 may include both historical CR data and historical environmental features. Accordingly, the predictive machine learning model 248 may be a dynamic machine learning model which is trained iteratively based on new change request data. In other words, the predictive machine learning model 248 may be configured to enhance its predictive precision based on more data being included in the historical dataset 244. In embodiments, the predictive machine learning model 248 outputs a predicted outage of the planned change request to the scoring component 254. In embodiments, the predictive machine learning model 248 also outputs and estimates effect magnitude associated with predicted outage of the planned change request to the scoring component 254.

In aspects of the present invention, the scoring component 254 scores the predicted outage of the planned change request on a scale which indicates whether the outage of the planned change request is a low risk of an outage or a high risk of an outage. In an example, the scoring component 254 scores a 30% outage probability of a planned change request as a 3, which indicates that the planned change risk has a low risk. In another example, the scoring component scores a 60% outage probability of a planned change request as a 6, which indicates that the planned change risk has a high risk. In these examples, scoring between 0 and 5 may be classified as a low risk while scoring between 5 and 10 may be classified a high risk. In embodiments, the scoring component 254 also accounts for an estimated magnitude associated with the predicted outage. For example, if there is a 50% outage probability with an estimated magnitude of one week downtime of critical infrastructure components, then the scoring component 254 scores this as a 6.5, which indicates a higher risk than would normally be scored because the estimated magnitude of critical infrastructure components is high. If the predicated outage of the planned change request is a low risk, the predicted outage of the planned change request may be sent to the plurality of low risk planned CRs 258. However, if the predicated outage of the planned change request is a high risk, an adjustment of the predicted outage of the planned change request may be made at the adjustment component 256. In other words, the adjustment component 256 may adjust the predicted outage of the planned change request to lower the risk and then send the adjusted predicted outage of the planned change request to the plurality of accumulated planned CRs 252. The plurality of accumulated planned CRs 252 may also receive low risk planned CRs from the plurality of low risk planned CRs. The plurality of accumulated planned CRs 252 may then send this information back to the scoring component 254 for re-scoring. This process may be repeated again until the predicted outage of the planned change request is a low risk.

FIG. 4 shows an example of an island graph associated with the risk estimator 226 of FIG. 3 in accordance with aspects of the present invention. In embodiments, the island graph 260 is a directed connected graph such that each element of vertices has neighbors inside the vertices. In FIG. 4, the island graph 260 comprises a root node 262 and offspring nodes 264. In the island graph 260, each node (whether root node 262 or offspring node 264) may include CR or RCA type, creation time, impact scope, and duration from opening to closing.

In the island graph 260 of FIG. 4, a CR is labeled as “1” when one of its offspring is a RCA (root cause analysis) of an outage or another CR. In this situation, when the CR is labeled as “1”, the CR would be the root of the island graph 260 (i.e., root node 262). The CR may be labeled as “0” when it has no RCAs as offspring or other related CR with RCAs as offspring. In this situation, when the CR is labeled as “0”, the CR would not be the root of the island graph 260. In other words, the labeling algorithm may generate a [0, 1] label for each CR depending on an outcome related to the outage. The labeling algorithm may produce an island for each of the CR using CR datasets and RCA datasets. In embodiments, the labeling algorithm may be used to generate attributes for each CR. The island graph 260 of FIG. 4 may be displayed through a user interface (UI) of a dashboard, but embodiments are not limited to a UI of a dashboard.

FIG. 5 shows an example of a block diagram that includes a label and attribute generator 234 associated with the risk estimator of FIG. 3 in accordance with aspects of the present invention. The block diagram 270 comprises the label and attribute generator 234, the ticket 236, the monitoring component 238, the CR 242, the island graph 260, a root cause analysis (RCA) component 272, a usage component 276, a filter and transformation component 278, a graph generation component 282, and a causal graph component 284. In further embodiments, each of the label and attribute generator 234, the ticket 236, the monitoring component 238, the CR 242, the island graph 260, the root cause analysis (RCA) component 272, the usage component 276, the filter and transformation component 278, the graph generation component 282, and the causal graph component 284 may include a software system with a user interface (UI) dashboard, hardware circuits, processor sets, and/or a combination of hardware and software.

In aspects of the present invention, the ticket 236 of FIG. 5 sends information to the RCA component 272 and the CR 242. Further, the monitoring component 238 monitors the environment and send usage information to the usage component 276. The RCA component 272 sends root cause analysis (RCA) information to the island graph 260. The island graph 260 may be generated and displayed based on the information from the RCA component 272 and information from the graph generation component 282. The graph generation component 282 is configured to send the information to create the island graph 260.

In embodiments, the island graph 260 is filtered and transformed based on information from the filter and transformation component 278 and sent to the causal graph component 284. In particular, the filter and transformation component 278 may filter and transform the islands in the island graph 260 and then send the filtered and transformed island graph 260 to the causal graph component 284.

In embodiments, the causal graph component 284 outputs causal graphs which are probabilistic graphical models used to encode assumptions about the data gathering process. In particular, the causal graphs output by the causal graph component 284 may use d-separation, which is a criteria for deciding whether a first set of variables is independent of a second set of variables, given a third set of variables. The causal graphs output by the causal graph component 284 may be sent to the label and attribute generator 234 for identifying CRs which may result in an outage by assigning a proper outage label.

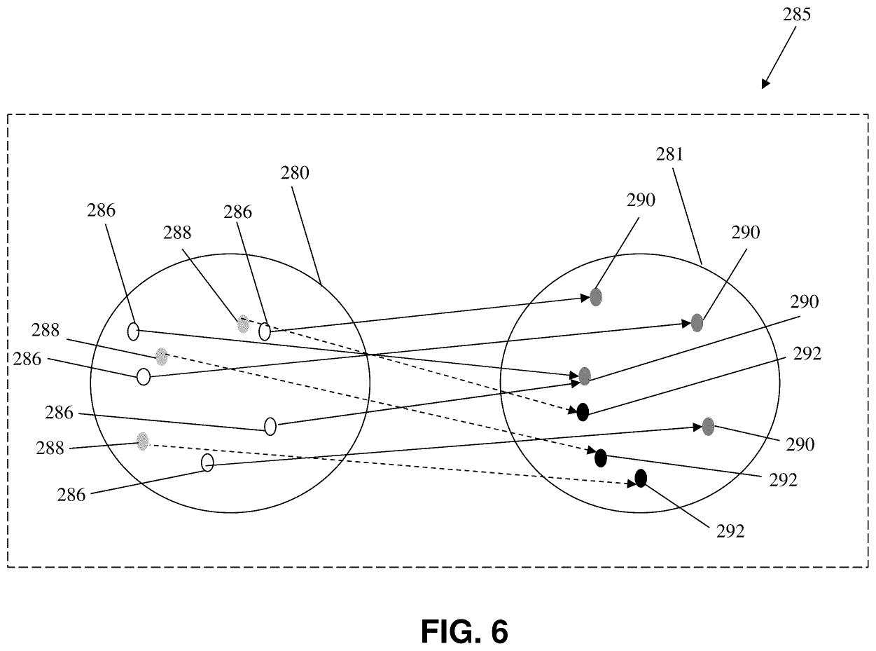

FIG. 6 shows an example of an attribute estimator associated with the risk estimator of FIG. 3 in accordance with aspects of the present invention. The attribute estimator 285 may be part of the predictive machine learning model 248 in FIG. 3. In embodiments of FIG. 6, the attribute estimator 285 may include a feature space 280 and an environment space 281. The feature space 280 of FIG. 6 may include a first set of feature objects 286 and a second set of feature objects 288. The environment space 281 of FIG. 6 may include a first set of environment objects 290 and a second set of environment objects 292. The feature objects may correspond with a change request and the environment objects may correspond with an environment when a change request was implemented. In FIG. 6, an attribute is represented by a. Accordingly, the attribute a corresponds with (feature object f, feature object e) or (f, e) for shorthand. The attribute estimator 285 is used to estimate attributes of a future change request as described herein.

In FIG. 6, the first set of features objects 286 in the feature space 280 represent actual change request data (i.e., historical change request data). In addition, the first set of environment objects 290 in the environment space 281 represent actual environmental data for the change request data (i.e., historical environmental data for the historical change request data). The first set of objects 286 are mapped to the first set of environment objects 290 and represented by a solid line. For the first set of objects 286 mapped to the first set of environment objects 290, the actual attributes would correspond with an outage (i.e., outage=1, no outage=0). In other words, the historical data of the change request data and the environmental data may be used to predict an actual attribute of a planned change request by computing a probability of an outage.

In the example of FIG. 6, the second set of features object 288 represents planned change requests. Based on historical data of the change request data and the environmental data, a second set of environmental objects 292 may be projected for the second set of features object 288. The projected mapping between the second set of features object 288 and the projected second set of environmental objects 292 is represented by a dashed line.

In further details of the attribute estimator 285, by using the data pairs (feature object f, feature object e) or (f, e) for shorthand and attribute a, the set of conditions under which the risk of outage is high is predicted. For example, by feeding the data pair (f, e) and attribute a into a machine learning (ML) algorithm of the predictive machine learning model 248 implemented as a decision tree, rules may obtained as follows:

$$If Job = drive replacement AND storage utilization > 0.8 , then Prob ( Outage ) = 0.9 ( Rule 1 ) ;$$

$$If Job = drive replacement AND storage utilization = < 0.8 , then Prob ( Outage ) = 0.2 ( Rule 2 ) ;$$

In the attribute estimator 285, the data pairs (f, e) are reduced to relevant data pairs (f*,e*) based on the relevant features that are important in the ML algorithm of the predictive machine learning model 248 implemented as the decision tree. In other words, the ML algorithm of the predictive machine learning model 248 implemented as the decision tree may reduce the data pairs (f, e) to a sub-set of relevant data pairs (f*, e*) based on using only certain combinations of sub-features that represent actual risk factors.

In the attribute estimator 285, a planned data pair (f₀, e₀) is submitted to the ML algorithm of the predictive machine learning model 248 implemented as the decision tree with a projected situation which exists in planned data: Job=drive replacement AND storage utilization (projected at launch)=0.85 (Projected).

In the attribute estimator 285, the determined probability of the outage is greater than 0.9 based on the projected situation above. In further embodiments, other features may be detected (e.g., usage of services supported by the impacted change) that pose additional risks that lead to the determined probability of the outage being greater than 0.99. Also, in embodiments, although the ML algorithm is described as using a decision tree in the predictive machine learning model 248, embodiments are not limited and other ML algorithms may be used depending on the data pair (f, e).

In another example of the attribute estimator 285, a change request for a hard-drive failure is planned. In particular, the change request may include a hard drive replacement. The feature sets f for this change request may include the issue_key, created, summary, assignment_group, issue_description, category, change_reason, assignee, reporter, creater, description, affected_area, business_impact, business_justification, change_type, expected_business_outcome, impact, planned_duration_hrs, planned execution time, and customer_request type. The feature sets e for this change request may include environment_key, request_created, environment_time, summary, area_coverage, customers_served, jobs_running, cpus_active, avg_cpu_utilization_pct, io_intensity, HDD_read_intensity, HDD_write_intensity, avg_network_utilization, on_site_support_level, and external_factors. Therefore, in this scenario, there are many data pairs of (f, e). However, most of these features and environment sets don't matter (i.e., aren't relevant) for this change request (e.g., assignee, reporter, creator, customers_served, etc.) Accordingly, the ML algorithm may reduce the data pairs (f, e) to a sub-set of relevant data pairs (f*, e*) based on using only certain combinations of sub-features that represent actual risk factors. For example, the relevant data pairs (f*, e*) may be based on a description of the feature set f* (i.e., “crash occurred during system maintenance”) and external factors of the feature set e* (i.e., “first monday of the new year”). However, embodiments may not be limited, and other relevant data pairs (f*, e*) may be used that represent actual risk factors for the hard drive replacement change request. In an example, based on the relevant data pairs (f*, e*), the ML algorithm may calculate that the risk of outage is 0.67 and the expected loss in case of the outage is $2,000.

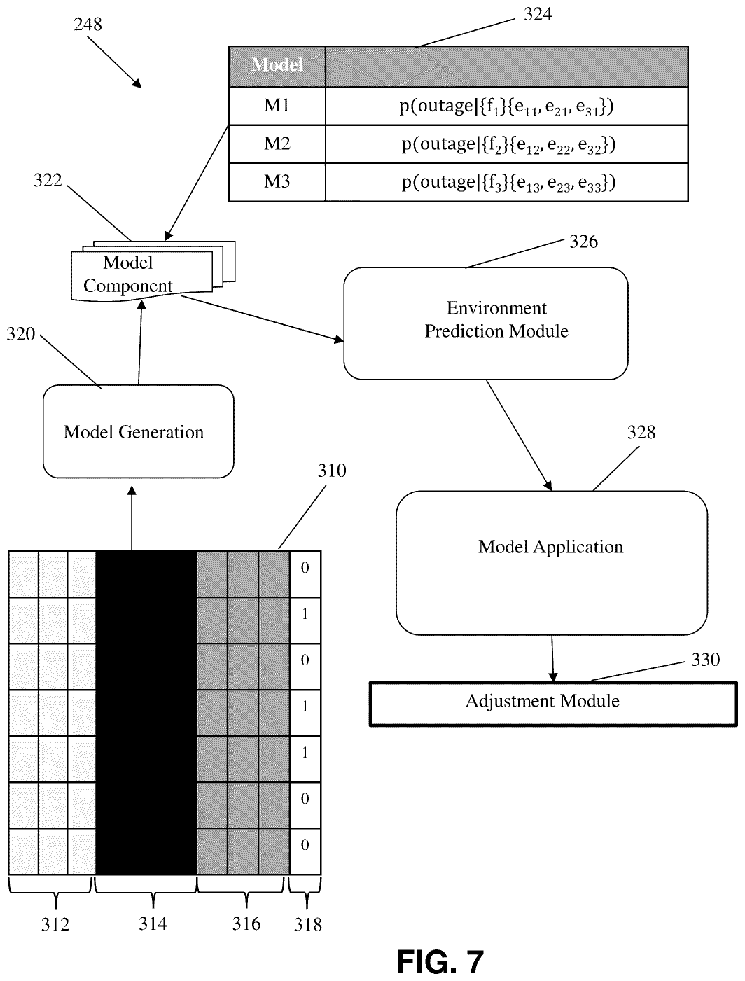

FIG. 7 shows an example of a predictive machine learning model associated with the risk estimator of FIG. 3 in accordance with aspects of the present invention. In FIG. 7, the predictive machine learning model 248 may include a model table 310, a model generation module 320, a model component 322, a list of models 324, an environment prediction module 326, a model application 328, and an adjustment module 330. In embodiments, the model table 310 may include the feature sets of historical change requests 312, the feature sets of environmental objects 314, other features 316 (i.e., actions, controls, etc.), and response outage 318 (outage=1, no outage=0). For example, control features 316 may be features which are adjusted to mitigate a risk impact of the CR on the system. As shown in the model table 310 of FIG. 7, there is an outage (i.e., outage=1) for feature sets of historical change requests 312, feature sets of environmental objects 314, and other features 316 which correspond to the second row, the fourth row, and the fifth row. The information in the model table 310 may be sent to the model generation module 320.

In aspects of the present invention, the model generation module 320 is configured to generate at least one model for at least one CR which is stored in the model component 322 based on the information in the model table 310. In particular, the model generation module 320 generates a model which predicts a probability of an outage based on the feature sets of historical change requests 312, the feature sets of environmental objects 314, other features 316, and response outage 318. For example, the model generation 320 generates a model which has a high probability of an outage based on the feature sets of historical change requests 312, the feature sets of environmental objects 314, other features 316, and response outage 318 in the second row of the model table 310 (i.e., the second row of the model table 310 has the response outage 318=1). Accordingly, the model generation module 320 generates at least one model which is used to predict a probability of an outage of a planned CR based on similar feature sets of historical change requests 312, feature sets of environmental objects 314, and other features 316. In further embodiments, the model component 322 may contain the list of models 324. In an example, the list of models 324 may contain three models: M1, M2, and M3. The list of models 324 may also list the probabilities of outages for models M1, M2, and M3. Although embodiments show three models in the list of models 324, embodiments are not limited. The list of models 324 may contain any number of models. The model component 322 may send information about the at least one model to the environment prediction module 326.

In aspects of the present invention, the environment prediction module 326 is configured to predict an environment and/or environmental variables at the time the CR is implemented. In particular, the environment prediction module 326 predicts an environment and/or environmental variables at the time the CR is implemented by looking at the feature sets of environmental objects 314 which correspond to historical change requests stored in the model component 322. In other words, the environmental prediction module 326 predicts an environment and/or environmental variables at the time the CR is implemented by looking at data from historical change requests. The environment prediction module 326 may then send the predicted environment and/or environmental variables to the model application 328.

In aspects of the present invention, the model application 328 is a user interface (UI) on a device. In particular, the model application 328 may present the probabilities of outages for each model and the environment and/or environmental variables to the user through the device. If the user does not require any adjustment to any of the models, the predictive machine learning model 248 may not need to perform any additional steps. However, if the user requires an adjustment to the models, the model application 328 may send the probabilities of outages for each model and the environment and/or environmental variables to the adjustment module 330.

In aspects of the present invention, the adjustment module 330 performs an adjustment to the CR. For example, the adjustment module 330 may either reschedule the CR corresponding with one of the models or abandon the CR corresponding with one of the models. The adjustment module 330 may also split the CR related to one of the models into multiple smaller CRs to mitigate a risk of an outage. In addition, the adjustment module 330 may perform preventative remediation task generation on a CR related to one of the models. As described above, the adjustment module 330 may be an optional module which is only used when adjustment to CRs are needed.

FIG. 8 shows a block diagram of a risk mitigator of FIG. 2 in accordance with aspects of the present invention. In FIG. 8, the block diagram of the risk mitigator 228 includes the risk estimator 226, the change request (CR) 242, a list of adjustable features 342, a fixed features component 344, an adjustable features component 346, a risk optimizer 350, and a list of feasible actions 352. In embodiments, the risk estimator 226, the change request (CR) 242, a list of adjustable features 342, a fixed features component 344, an adjustable features component 346, a risk optimizer 350, and a list of feasible actions 352 may include a software system with a user interface (UI) dashboard, hardware circuits, processor sets, and/or a combination of hardware and software.

In aspects of the present invention, the CR 242 provides information (e.g., hard drive replacement request, time to deploy a hard drive, staff deployment to handle calls relating to the hard drive replacement request, etc.) to the fixed features component 344 and the adjustable features component 346. The adjustable features component 346 includes adjustable features which are a subset of features that may be adjusted in a process of change management. For example, a time of patch deployment may be adjusted to ensure that professional staff may support post-deployment calls from users. The adjustable features component 346 may include the list of adjustable features 342. The list of adjustable features 342 may include a time to deploy, a pace of change implementation, etc. However, the list of adjustable features 342 is not limited to this example and may include any features that are adjusted in a CR. The fixed features component 344 includes fixed features, such as replacing a hard drive. Fixed features are features which may not be adjusted in a CR. Both the fixed features from the fixed features component 344 and the adjustable features from the adjustable features component 346 may be sent to the risk optimizer 350.

In aspects of the present invention, the risk optimizer 350 receives the fixed features, the adjustable features, and the planned CRs and outage probabilities from the risk estimator 226. In particular, the risk optimizer 350 may be configured to identify all possible actions based on the received fixed features, adjustable features, planned CRs, and outage probabilities. For each possible action, the risk optimizer 350 may compute an overall risk position and overall score. The risk optimizer 350 may then order each possible action by the overall risk position and overall score. Each possible action which decreases a risk profile may then be output from the risk optimizer 350 as the list of feasible actions 352. In other words, the list of feasible actions 352 may be a list of actions which improve the risk profile.

As detailed below, the risk optimizer 350 identifies all possible actions and a list of feasible actions using a risk effect calibrator (REC) and an action generator (AG) described below. As described below, the risk effect calibrator (REC) uses the fixed features, adjustable features, planned CRs, and outage probabilities to identify all possible actions (e.g., actions a₀, a₁, a₂, etc.) and their overall risk positions and scores. The action generator (AG) then uses all of the possible actions (e.g., actions a₀, a₁, a₂, etc.) in the REC to generate (select) a list of feasible actions based on the values of the functions (Φ₁, Φ₂, . . . , Φₘ) applied to the calibrated scores (see paragraph and other descriptions herein).

In aspects of the present invention, the risk optimizer 350 includes the risk effect calibrator (REC). The REC evaluates an effect of a given action on a risk estimate of a CR and converts the effect of the given action to a calibrated effect number. The REC is configured to present all effects on a single scale so that the effects can be effectively compared to each other. The REC includes a formula as specified below:

$$s = ψ ( {p}_{1} , {p}_{2} \vert Z ) . \qquad ( formula 1 )$$

Formula 1 above produces an evaluation s of the effect if the probability of outage p₁ is changed (e.g., usually as a result of some action) to p₂. The vector Z represents specific information about the conditions under which the change p₁ to p₂ is achieved. The values (p₁, p₂) are typically estimated from the model which provides the probability of outage as a function of (f, e) corresponding to the CR of interest CR₀ and features corresponding to other CRs in the queue that are scheduled to be executed prior to CR₀. In embodiments, the model associated with the REC is of a causal type and is not merely a descriptive type. In other words, if a particular action moves the system {(f, e)}₁ of the CRs in the queue to a new system {(f, e)}₂, then the corresponding estimated value p₁ moves to p₂.

As an example, in a current queue CR₁, an estimated probability p₁=0.02 of causing an outage and implementation of an action a₀ leads to a reduced outage probability p₂=0.01. The effect may depend on Z=1 if CR₁ Is deployed during a weekday or Z=0 if CR₁ is deployed during the weekend. The REC may specify the values as below:

$${Ψ}_{a c t i o n} {=}_{a 0 , CR = CR 1} ( {p}_{1} = 0.02 , {p}_{2} = 0.01 \vert Z = 1 ) = - 2 ; \qquad ( first value )$$

$${Ψ}_{action} {=}_{a 0 , CR = CR 1} ( {p}_{1} = 0.02 , {p}_{2} 0.01 \vert Z = 0 ) = - 1. \qquad ( second value )$$

In the first and second values above, Ψ_{action} is computed under the assumption that the action taken is a₀ and the considered change request is CR₁. Further, as shown above in the first and second values, the effect of action a₀ on CR₁ is valued two times higher if CR₁ is deployed over a weekday than when CR₁ is deployed over a weekend. In particular, during the weekend, the probability of an outage (i.e., 0.02) is not considered to be very high because the effect of such an outage is more manageable and/or involves fewer customers. Note that a negative sign (“-”) may be viewed as a form of a value derived from implementation of the action a₀ in relation to deployment of CR₁.

In aspects of the present invention, the risk optimizer 350 includes an action generator (AG) which is configured to produce a list of actions {a₁, a₂, . . . , aₗ} that may be implemented at a given time t. In particular, the risk optimizer 350 may rank order these actions in terms of their potential for overall risk posture improvement of the CR queue 210 consisting of change requests {CR₁, CR₂, . . . , CR_{q}). In particular, the first matrix is shown as:

$$S = [ \begin{matrix}{s}_{11} & {s}_{12} & … & {s}_{1 q}\end{matrix} ] \qquad ( first matrix )$$

$$[ \begin{matrix}{s}_{21} & {s}_{22} & … & {s}_{2 q}\end{matrix} ]$$

$$[ \begin{matrix}… & … & … & …\end{matrix} ]$$

$$[ \begin{matrix}{s}_{11} & {s}_{12} & … & {s}_{1 lq}\end{matrix} ]$$

As shown in the first matrix, s_{1q}=Ψ_{action}=a₁, _{CR=CR}_{_{q}} (p₁, p₂|Z), which is a value provided by the REC under an assumption that the action is aₗ and the risk effect may be measured with respect to the CR_{q}.

In aspects of the present invention, in a next step, a system of constraints is established. Among a set of actions produced by the AG, the AG may specify a list of feasible actions. The AG may specify the functions φₘ (s₁, s₂, . . . , s_{q}), for m=1, 2, . . . , M representing the M features associated with the scores (s₁, s₂, . . . , s_{q}). In particular, the AG may generate a feasible action in the second formula if:

$${Φ}_{m} ( {s}_{1} , {s}_{2} , … , {s}_{q} ) \leq {u}_{m} , for m = 1 , 2 , … , M . \qquad ( second formula )$$

In the second formula, μm is a threshold associated with a m-th feature. For example, the AG may also define third and fourth formulas:

$${Φ}_{1} ( {s}_{1} , {s}_{2} , … , {s}_{q} ) = max ( {s}_{1} , {s}_{2} , … , {s}_{q} ) ; and \qquad ( third formula )$$

$${Φ}_{1} ( s 1 , s 2 , … , {s}_{q} ) = proportion of ( s 1 , s 2 , … , {s}_{q} ) exceeding ( - 1 ) . \qquad ( fourth formula )$$

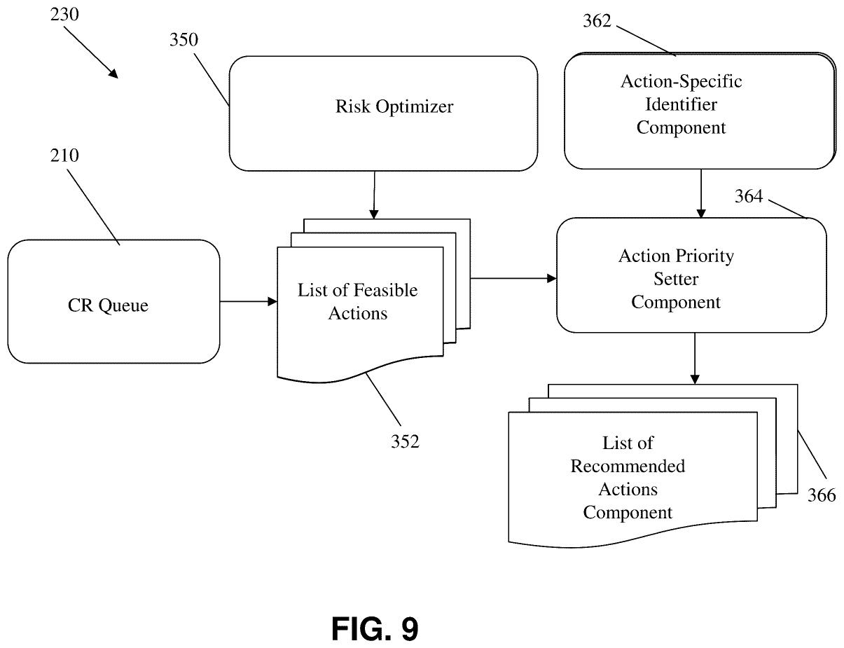

FIG. 9 shows a block diagram of an action recommender of FIG. 2 in accordance with aspects of the present invention. In FIG. 9, the block diagram of the action recommender 230 includes the CR queue 210, the risk optimizer 350, the list of feasible actions 352, an action-specific factor identifier component 362, an action priority setter component 364, and a list of recommended actions component 366. In embodiments, the risk optimizer 350, the action-specific factor identifier component 362, the action priority setter component 364, and the list of recommended actions component 366 may include a software system with a user interface (UI) dashboard, hardware circuits, processor sets, and/or a combination of hardware and software.

In aspects of the present invention, information from the CR queue 210 is sent to the list of feasible actions 352. Information from the risk optimizer 350 is also sent to the list of feasible actions 352. In embodiments, the information in the list of feasible actions 352 are focused on the risk profile (e.g., probability of an outage). The information in the list of feasible actions 352 may then be sent to the action priority setter component 364.

In aspects of the present invention, the action priority setter component 364 receives information from the list of feasible actions 352 and the action-specific identifier component 362. As an example, the action-specific identifier component 362 may send different action-specific factor identifiers, such as cost, implementation speed, etc. Then, the action priority setter component 364 uses the information from the list of feasible actions 352 and prioritizes the list of feasible actions 352 by the action-specific identifier (e.g., cost) received from the action-specific identifier component. As an example, the list of feasible actions 352 may be prioritized by cost. However, embodiments are not limited, and the action-specific identifier may be user defined through the UI dashboard. The prioritized list of feasible actions 352 is then sent to the list of recommendation actions component 366.

In aspects of the present invention, the list of recommendation actions component 366 receives the prioritized list of feasible actions 352 and then creates a list of recommended actions which takes into account the prioritized list of feasible actions 352 and other constraints in the system.

In further detail, the list of recommendation actions component 366 includes an action recommender component which identifies all data pairs (f, e) in all planned CRs that may be adjusted in order to reduce the risks to a specific CR. For example, if CR1 involves a deployment of a new version of an operating system and CR0 involves a deployment of a new backup server, then the data pair (f, e) corresponding to CR₁ may be adjusted to mitigate the risks related to CR0.

In aspects of the present invention, the action recommender component of the list of recommendation actions component 366 may (i) for every CR0, produce a list of actions related to other CRs in a queue that may reduce the risk to CR0; (ii) ensure that the list of actions does not increase the risks to other CRs to a measurable degree; (iii) explore changes to CR0, and for every change, validate that the identified actions related to other CRs that are still beneficial; (iv) produce a list of feasible actions related to CR0 and other CRs that lead to risk reduction with respect to CR0 without leading to an increase in risks to other CRs; and (v) produce a prioritized list of recommended actions that also incorporate action-specific identifiers (e.g., costs). In summary, for a CR0 which is close to a launch point or deployed implementation, the risk-reducing actions of interest may be related to its own decision pair (f, e). In this scenario, when the CR0 is close to the launch point, other changes in the queue may not do much to affect the CR0. In contrast, when the CR0 is far away from the launch point or deployed implementation, the action recommender component may find actions in which CR modifications may be scheduled and launched before CR0 to improve the risk profile.

In aspects of the present invention, the action recommender component is also configured to compute an objective function Φ₀ (s₁, s₂ . . . , s_{q}) that measures a benefit of an action. The action recommender component may select, among the actions {a₁, a₂ . . . aₗ}, a best or optimized action ai using the following fifth formula:

$$Minimize {Φ}_{0} ( s 1 , s 2 , … , {s}_{q} ) , \qquad ( fifth formula )$$

subject to constraints Φ₁(s₁, s₂ . . . , s_{q})=proportion of (s₁, s₂ . . . , s_{q}) exceeding (−1) from fourth formula.

In the fifth formula above, the action recommender component is looking for the best or optimized action ai. The variables (s₁, s₂ . . . , s_{q}) may be obtained from rows of the first matrix above and may be determined based on the best or optimized action ai.

In another aspect of the present invention, the action recommender component selects {a₁, a₂ . . . aₗ} that satisfies the constraints of the fifth formula, rank-order the reduced list of actions based on the values of Φ₀ (s₁, s₂ . . . , s_{q}), and implement best Lo actions. The action recommender component may also use Do (s₁, s₂ . . . , s_{q})=average of (s₁, s₂ . . . , s_{q}).

In aspects of the present invention, the action recommender component estimates costs {c₁, C₂ . . . , cₗ} associated with the actions {a₁, a₂ . . . aₗ}. For example, the action recommender component may establish a rank-order using costs based on (1/c)*Φ₀(s₁, s₂ , . . . s_{q}), where c is the cost associated with the action. In this scenario, the action recommender may rank-order the actions such that costly actions are less attractive (i.e., ranked lower).

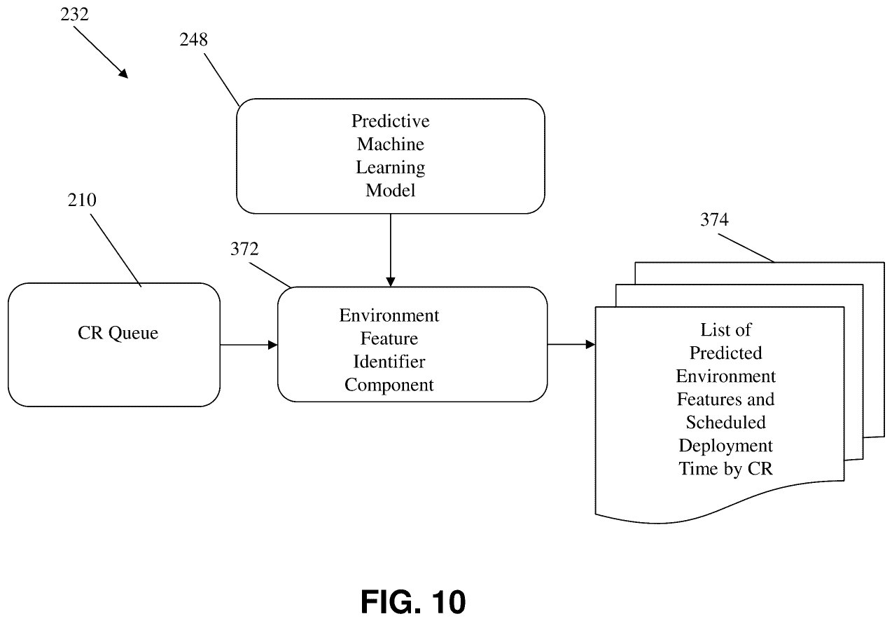

FIG. 10 shows a block diagram of an environment predictor of FIG. 2 in accordance with aspects of the present invention. In FIG. 10, the block diagram of the environment predictor 232 of FIG. 2 includes the CR queue 210, the predictive machine learning model 248, the environment feature identifier component 372, and a list of predicted environment features and scheduled deployment time by CR 374. In embodiments, the predictive machine learning model 248 and the environment feature identifier component 372 may include a software system with a user interface (UI) dashboard, hardware circuits, processor sets, and/or a combination of hardware and software.

In aspects of the present invention, information from the CR queue 210 is sent to the environment feature identifier component 372. The environment feature identifier component 372 receives the information from the CR queue 210 and information from the predictive machine learning model 248 and outputs the list of predicted environment features and scheduled deployment time by CR 374. In particular, the environment feature identifier component 372 receives information from models of the predictive machine learning model 248 and information from the CR queue 210 to identify features of the environment that have a risk impact. The environment feature identifier component 372 may look at an overall load of the system on the planned implementation date, the planned implementation date (e.g., does this planned implementation occur on Black Friday), the computing resources needed on the planned implementation data, and available support personnel on the planned implementation date to identify the features of the environment that have a risk impact. In particular, the list of predicted environment features and scheduled deployment time by CR 374 output from the environment feature may be used by support personnel or an automated computing system to determine whether to go forward with the planned CR. In embodiments, the environment feature identifier component 372 may re-evaluate the CR queue 210 continuously or may schedule time points for re-evaluation even if no actions are implemented.

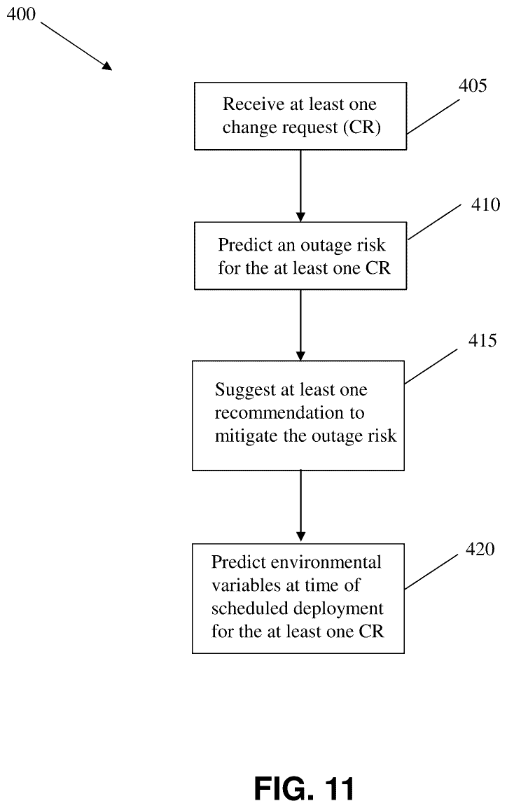

FIG. 11 shows a flowchart of an exemplary method in accordance with aspects of the present invention. Steps of the method 400 may be carried out in the environment of FIG. 2 and are described with reference to elements depicted in FIG. 2.

At step 405, the system receives, at a risk estimator 226, at least one change request (CR). In embodiments, and as described with respect to FIG. 2, each CR of the at least one CR comprises a formal proposal for an alteration or modification to a product or system in a cloud hosting operation. At step 410, the system predicts, at the risk estimator 226, an outage risk for the at least one CR. In embodiments, and as described with respect to FIG. 2, the outage risk for the at least one CR may be computed using a predictive machine learning model 248 which takes into account historical CR data and historical environmental features. The predictive machine learning model 248 may also take into account control features.

At step 415, the system suggests, at an action recommender 230, at least one recommendation which mitigates the outage risk for the at least one CR. In embodiments, and as described with respect to FIG. 2, the at least one recommendation may be an alternative action for the at least one CR or a modification of the at least one CR. At step 420, the system, at an environment predictor 232, predicts environmental variables at a time of scheduled deployment for the at least one CR. In embodiments, and as described with respect to FIG. 2, the environmental variables may be features of the environment at the time of scheduled deployment of the CR which have a risk impact.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, at least one change request (CR) for a modification in a cloud environment;
predicting, by the processor set, an outage risk for the at least one CR in the cloud environment using a predictive machine learning model which predicts based on historical data and historical features; and
suggesting, by the processor set, at least one recommendation to mitigate the outage risk for the at least one CR in the cloud environment.

2. The method of claim 1, further comprising predicting a plurality of environmental variables at a time of scheduled deployment for the at least one CR in the cloud environment.

3. The method of claim 1, wherein the outage risk for the at least one CR is predicted using the predictive machine learning model which predicts based on historical CR data and historical environmental features.

4. The method of claim 3, wherein the historical CR data comprises at least one feature of the historical CR data and the historical environment features comprises at least one feature of a cloud environment at a time of a schedule deployment of a historical CR.

5. The method of claim 3, wherein the predictive machine learning model is trained using the historical CR data and the historical environmental features to predict the outage risk for the at least one CR.

6. The method of claim 3, wherein the predictive machine learning model predicts based on control features which are adjusted to mitigate a risk impact of the at least one CR.

7. The method of claim 3, wherein the predictive machine learning model is further configured to estimate a magnitude of the outage risk for the at least one CR.

8. The method of claim 1, wherein the at least one recommendation to mitigate the outage risk for the at least one CR comprises an alternative action for the at least one CR.

9. The method of claim 1, wherein the at least one recommendation to mitigate the outage risk for the at least one CR comprises a modification of an action for the at least one CR.

10. The method of claim 1, wherein the at least one recommendation comprises a plurality of recommendations which are rank-ordered based on a cost associated with a corresponding recommendation.

11. The method of claim 1, further comprising generating an island graph for the at least one CR using historical CR data and root cause analysis (RCA) data.

12. A computer program product comprising one or more computer readable storage media having program instructions collectively stored on the one or more computer readable storage media, the program instructions executable to:
receive at least one change request (CR) for a modification in a cloud environment;
predict an outage risk for the at least one CR in the cloud environment using a predictive machine learning model which predicts based on historical data and historical features;
suggest at least one recommendation to mitigate the outage risk for the at least one CR in the cloud environment; and
predict a plurality of environmental variables at a time of scheduled deployment for the at least one CR in the cloud environment.

13. The computer program product of claim 12, wherein the outage risk for the at least one CR is predicted using the predictive machine learning model which predicts based on historical CR data and historical environmental features.

14. The computer program product of claim 13, wherein the historical CR data comprises at least one feature of the historical CR data and the historical environment features comprises at least one feature of a cloud environment at the time of schedule deployment time for a historical CR.

15. The computer program product of claim 13, wherein the predictive machine learning model is trained using the historical CR data and the historical environmental features to predict the outage risk for the at least one CR.

16. The computer program product of claim 13, wherein the predictive machine learning model predicts based on control features which are adjusted to mitigate a risk impact of the at least one CR.

17. The computer program product of claim 13, wherein the predictive machine learning model is further configured to estimate a magnitude of the outage risk for the at least one CR.

18. A system comprising:
a processor set, one or more computer readable storage media, and program instructions collectively stored on the one or more computer readable storage media, the program instructions executable to:
receive at least one change request (CR) for a modification in a cloud environment;
predict an outage risk for the at least one CR in the cloud environment using a predictive machine learning model which predicts based on historical data and historical features;
estimate a magnitude of the outage risk for the at least one CR in the cloud environment; and
suggest at least one recommendation to mitigate the outage risk for the at least one CR in the cloud environment.

19. The system of claim 18, wherein the outage risk for the at least one CR and the magnitude of the outage risk for the at least one CR is predicted using the predictive machine learning model which predicts based on historical CR data and historical environmental features.

20. The system of claim 19, wherein the predictive machine learning model is trained using the historical CR data and the historical environmental features to predict the outage risk for the at least one CR.
